(19) United States
(12) Patent Application Publication
(10) Pub. No.: US 2014/0268924 A1
(43) Pub. Date: Sep. 18, 2014

(54) CONTROL CIRCUIT FOR FLYBACK POWER CONVERTER AND CALIBRATION METHOD THEREOF

(71) Applicant: Richtek Technology Corporation, Hsinchu County (TW)

(72) Inventors: Chien-Fu TANG, Hsinchu City (TW); Isaac Y. CHEN, Hsinchu County (TW)

(21) Appl. No.: 13/928,974

(22) Filed: Jun. 27, 2013

(30) Foreign Application Priority Data
Mar. 13, 2013 (TW) 102108926

(51) Int. Cl. H02M 3/335

(52) U.S. Cl. CPC H02M 3/33507
USPC 363/21.17

(57) ABSTRACT

A control circuit of a flyback power converter includes a first reference signal generating circuit for generating a first reference signal; a reference signal adjusting circuit for generating an adjustment signal according to the first reference signal and a test signal corresponding to an output voltage signal of the flyback power converter, and to generate a second reference signal according to the adjustment signal and the first reference signal; an error detection circuit for generating an error signal according to the second reference signal and a feedback signal; and a control signal generating circuit for generating a control signal according to the error signal to control operations of a power switch to thereby adjust the test signal. The feedback signal corresponds to a current flowing through a primary side coil of the power converter or a sensing voltage of an inductive coil of the power converter.

### CROSS-REFERENCE TO RELATED APPLICATIONS

This application claims the benefit of priority to Patent Application No. 102108926, filed in Taiwan on Mar. 13, 2013; the entirety of which is incorporated herein by reference for all purposes.

### BACKGROUND

The disclosure generally relates to a flyback power converter and, more particularly, to a control circuit for use in the flyback power converter and related controlling methods.

In the flyback power converter, an output voltage or an output current of a primary side circuit is inducted to a secondary side coil through a primary side coil, so that a secondary side circuit operates accordingly. During the signal induction, parameter variations of some circuit components usually cause an output voltage or an output current of the secondary side circuit to be unstable or deviate from the target value. The aforementioned parameter variations may be, for example, the variation in the ratio of the primary side coil to the secondary side coil, the variation in manufacturing processes of the primary side coil and the secondary side coil, or the variation of a diode in the secondary side circuit.

However, in the related manufacturing art of the circuit components, the parameter variations of the circuit components of the flyback power converter are very difficult to be completely eliminated. If the control circuit of the flyback power converter is not able to solve the problems caused by the parameter variations of the aforementioned circuit components, the flyback power converter would not be able to provide an ideal output voltage signal for subsequent-stage circuits.

### SUMMARY

An example embodiment of a control circuit of a flyback power converter is disclosed. The flyback power converter comprises a power switch, a primary side coil, a secondary side coil, and an inductive coil. The control circuit comprises a first reference signal generating circuit, configured to operably generate a first reference signal; a reference signal adjusting circuit, coupled with the first reference signal generating circuit, configured to operably generate an adjustment signal according to a test signal corresponding to an output voltage signal of the flyback power converter and the first reference signal, and to operably generate a second reference signal according to the adjustment signal and the first reference signal when the reference signal adjusting circuit is coupled with the test signal; an error detection circuit, coupled with the reference signal adjusting circuit, configured to operably generate an error signal according to the second reference signal and a feedback signal; and a control signal generating circuit, coupled with the error detection circuit, configured to operably generate a control signal according to the error signal to control operations of the power switch to thereby adjust the test signal; wherein the feedback signal corresponds to a current flowing through the primary side coil or corresponds to a sensing voltage of the inductive coil.

Another example embodiment of a control circuit of a flyback power converter is disclosed. The flyback power converter comprises a primary side coil, a secondary side coil, and an inductive coil. The control circuit comprises a power switch, for coupling with one terminal of the primary side coil; a first reference signal generating circuit, configured to operably generate a first reference signal; a reference signal adjusting circuit, coupled with the first reference signal generating circuit, configured to operably generate an adjustment signal according to a test signal corresponding to an output voltage signal of the flyback power converter and the first reference signal, and to operably generate a second reference signal according to the adjustment signal and the first reference signal when the reference signal adjusting circuit is coupled with the test signal; an error detection circuit, coupled with the reference signal adjusting circuit, configured to operably generate an error signal according to the second reference signal and a feedback signal when coupled with the flyback power converter; and a control signal generating circuit, coupled with the error detection circuit, configured to operably generate a control signal according to the error signal to control the power switch to thereby adjust the test signal; wherein the feedback signal corresponds to a current flowing through the primary side coil or corresponds to a sensing voltage of the inductive coil.

Another example embodiment of a control circuit of a flyback power converter is disclosed. The flyback power converter comprises a power switch, a primary side coil, a secondary side coil, and an inductive coil. The control circuit comprises a first reference signal generating circuit, configured to operably generate a first reference signal; a reference signal adjusting circuit, coupled with the first reference signal generating circuit, configured to operably generate an adjustment signal according to a test signal corresponding to an output voltage signal of the flyback power converter and an external reference signal, and to operably generate a second reference signal according to the adjustment signal and the first reference signal when the reference signal adjusting circuit is coupled with the test signal; an error detection circuit, coupled with the reference signal adjusting circuit, configured to operably generate an error signal according to the second reference signal and a feedback signal when coupled with the flyback power converter; and a control signal generating circuit, coupled with the error detection circuit, configured to operably generate a control signal according to the error signal to control operations of the power switch to thereby adjust the test signal; wherein the feedback signal corresponds to a current flowing through the primary side coil or corresponds to a sensing voltage of the inductive coil.

Another example embodiment of a control circuit of a flyback power converter is disclosed. The flyback power converter comprises a primary side coil, a secondary side coil, and an inductive coil. The control circuit comprises a power switch, for coupling with one terminal of the primary side coil; a first reference signal generating circuit, configured to operably generate a first reference signal; a reference signal adjusting circuit, coupled with the first reference signal generating circuit, configured to operably generate an adjustment signal according to a test signal corresponding to an output voltage signal of the flyback power converter and an external reference signal, and to operably generate a second reference signal according to the adjustment signal and the first reference signal when the reference signal adjusting circuit is coupled with the test signal; an error detection circuit, coupled with the reference signal adjusting circuit, configured to operably generate an error signal according to the second reference signal and a feedback signal when coupled with the flyback power converter; and a control signal generating circuit, coupled with the error detection circuit, configured to operably generate a control signal according to the error signal to control the power switch to thereby adjust the test signal; wherein the feedback signal corresponds to a current flowing through the primary side coil or a sensing voltage of the inductive coil.

An example embodiment of a method for calibrating a control circuit of a flyback power converter is disclosed. The flyback power converter comprises a primary side coil, a secondary side coil, and an inductive coil. The control circuit comprises a first reference signal generating circuit, an error detection circuit, and a control signal generating circuit. The method comprises coupling the control circuit with a test signal corresponding to an output voltage signal of the flyback power converter; utilizing the first reference signal generating circuit to generate a first reference signal; generating an adjustment signal according to the first reference signal and the test signal; generating a second reference signal according to the adjustment signal and the first reference signal; utilizing the error detection circuit to generate an error signal according to the second reference signal and a feedback signal; and utilizing the control signal generating circuit to generate a control signal according to the error signal to control a power switch coupled with the primary side coil to thereby adjust the test signal; wherein the feedback signal corresponds to a current flowing through the primary side coil or corresponds to a sensing voltage of the inductive coil.

Another example embodiment of a method for calibrating a control circuit of a flyback power converter is disclosed. The flyback power converter comprises a primary side coil, a secondary side coil, and an inductive coil. The control circuit comprises a first reference signal generating circuit, an error detection circuit, and a control signal generating circuit. The method comprises coupling the control circuit with a test signal corresponding to an output voltage signal of the flyback power converter; utilizing the first reference signal generating circuit to generate a first reference signal; generating an adjustment signal according to an external reference signal and the test signal; generating a second reference signal according to the adjustment signal and the first reference signal; utilizing the error detection circuit to generate an error signal according to a feedback signal corresponding to the test signal and the second reference signal; and utilizing the control signal generating circuit to generate a control signal according to the error signal to control a power switch coupled with the primary side coil to thereby adjust the test signal.

Both the foregoing general description and the following detailed description are examples and explanatory only, and are not restrictive of the invention as claimed.

### BRIEF DESCRIPTION OF THE DRAWINGS

FIG. 1 shows a simplified functional block diagram of a flyback power converter according to a first embodiment of the present disclosure.

FIG. 2 shows a simplified functional block diagram of a flyback power converter according to a second embodiment of the present disclosure.

FIG. 3 shows a simplified functional block diagram of a flyback power converter according to a third embodiment of the present disclosure.

FIG. 4 shows a simplified functional block diagram of a flyback power converter according to a fourth embodiment of the present disclosure.

### DETAILED DESCRIPTION

Reference is made in detail to embodiments of the invention, which are illustrated in the accompanying drawings. The same reference numbers may be used throughout the drawings to refer to the same or like parts, components, or operations.

FIG. 1 shows a simplified functional block diagram of a flyback power converter 100 for testing according to one embodiment of the present disclosure. The flyback power converter 100 comprises a control circuit 110, a power switch 120, capacitors 132 and 134, diodes 136 and 138, a primary side coil 142, a secondary side coil 144, an inductive coil 146, a feedback circuit 150, and a sensing circuit 160. The capacitor 132 is coupled with an input voltage signal Sin of the flyback power converter 100, and configured to operably reduce the noise in the input voltage signal Sin. The capacitor 134 is coupled with an output terminal of the flyback power converter 100, and configured to operably reduce the noise in an output voltage signal Sout of the flyback power converter 100. The primary side coil 142, the secondary side coil 144, and the inductive coil 146 together form a transformer of the flyback power converter 100. One terminal of the primary side coil 142 is coupled with the input voltage signal Sin, and another terminal of the primary side coil 142 is coupled with the power switch 120. One terminal of the secondary side coil 144 is coupled with a fixed-voltage terminal (e.g., a ground terminal), and another terminal of the secondary side coil 144 is coupled with the output terminal of the flyback power converter 100. One terminal of the inductive coil 146 is coupled with a fixed-voltage terminal (e.g., a ground terminal), and another terminal of the inductive coil 146 is coupled with the control circuit 110 for providing the control circuit 110 with a required operating voltage VDD. The diode 136 is arranged between the secondary side coil 144 and the output terminal of the flyback power converter 100 to operably prevent current leakage in the output terminal of the flyback power converter 100. The diode 138 is arranged between the inductive coil 146 and the control circuit 110 to operably prevent current leakage in an input terminal of the operating voltage VDD. The feedback circuit 150 is coupled with the output terminal of the flyback power converter 100, and configured to operably generate a test signal TS corresponding to the output voltage signal Sout. The sensing circuit 160 is coupled between the inductive coil 146 and the diode 138, and configured to operably generate a corresponding feedback signal FB according to a sensing voltage of the inductive coil 146.

Each of the aforementioned feedback circuit 150 and the sensing circuit 160 may be realized with one or more appropriate voltage-divider circuits or one or more voltage-reducing circuits. In practice, the sensing circuit 160 may also comprise a sample-and-hold circuit (not shown) to conduct a sample-and-hold operation on the sensing voltage of the inductive coil 146, a voltage-divided version of the sensing voltage, or a voltage-reduced version of the sensing voltage to thereby increase the stability of the feedback signal FB.

For the purpose of explanatory convenience, other components in the flyback power converter 100 and related connections are not shown in FIG. 1.

As shown in FIG. 1, the control circuit 110 is coupled with a control terminal of the power switch 120 and the output terminal of the flyback power converter 100. The control circuit 110 is configured to operably control the operations of the power switch 120 to adjust the magnitude of the current flowing through the primary side coil 142, so that the flyback power converter 100 converts the input voltage signal Sin into the output voltage signal Sout having a desired magnitude.

Different functional blocks in the flyback power converter 100 may be respectively realized with different circuits, or may be integrated into a single circuit chip. For example, at least one of the power switch 120, the feedback circuit 150, and the sensing circuit 160 may be integrated into the control circuit 110.

In this embodiment, the control circuit 110 comprises a first reference signal generating circuit 111, a reference signal adjusting circuit 113, an error detection circuit 115, and a control signal generating circuit 117. The first reference signal generating circuit 111 is configured to operably generate a first reference signal Sref1. The reference signal adjusting circuit 113 is coupled with the first reference signal generating circuit 111. The reference signal adjusting circuit 113 is configured to operably generate an adjustment signal dS according to the test signal TS corresponding to the output voltage signal Sout of the flyback power converter 100 and the first reference signal Sref1, and to operably generate a second reference signal Sref2 according to the adjustment signal dS and the first reference signal Sref1 when the reference signal adjusting circuit 113 is coupled with the test signal TS. The error detection circuit 115 is coupled with the reference signal adjusting circuit 113, and configured to operably generate an error signal according to the second reference signal Sref2 and the feedback signal FB which is corresponding to the sensing voltage of the inductive coil 146. The control signal generating circuit 117 is coupled with the error detection circuit 115, and configured to operably generate a control signal according to the aforementioned error signal to control the power switch 120 to thereby adjust the output voltage signal Sout and the magnitude of the corresponding test signal TS.

In practice, the first reference signal generating circuit 111 may be realized with any kind of bias circuit, and the control signal generating circuit 117 may be realized with any kind of PWM signal generator or PFM signal generator. For example, the control signal generating circuit 117 may be realize with one or more flip-flops, one or more latches, or a combination of other logic circuits.

In the embodiment of FIG. 1, the reference signal adjusting circuit 113 comprises a signal difference detection circuit 161, an encoding circuit 163, a storage circuit 165, a digital-to-analog converter (DAC) 167, and a second reference signal generating circuit 169. The signal difference detection circuit 161 is coupled with the first reference signal generating circuit 111, and utilized for coupling with the test signal TS corresponding to the output voltage signal Sout. The encoding circuit 163 is coupled with the signal difference detection circuit 161. The storage circuit 165 is coupled with the encoding circuit 163. The DAC 167 is coupled with the storage circuit 165. The second reference signal generating circuit 169 is coupled with the DAC 167 and the first reference signal generating circuit 111.

In order to calibrate the internal parameters of the control circuit 110, the control circuit 110 may be coupled with the flyback power converter 100 for testing before shipment. The flyback power converter 100 for testing may generate the test signal TS corresponding to an ideal output voltage signal Sout by means of simulation. In the test stage, the signal difference detection circuit 161 of the reference signal adjusting circuit 113 compares the test signal TS with the first reference signal Sref1 outputted from the first reference signal generating circuit 111 to generate a difference signal. The encoding circuit 163 converts the difference signal into a digital value, and stores the digital value in the storage circuit 165. The DAC 167 converts the digital value stored in the storage circuit 165 into the analog adjustment signal dS. The second reference signal generating circuit 169 conducts operations on the adjustment signal dS and the first reference signal Sref1 to generate the second reference signal Sref2.

In one embodiment, the encoding circuit 163 may be realized with a divider circuit cooperating with an analog-to-digital converter (ADC). In this example, the divider circuit may convert the aforementioned difference signal into a divided signal, and the ADC may convert the divided signal into the aforementioned digital value.

In another embodiment, the encoding circuit 163 may be realized with a look-up table circuit. The look-up table circuit is stored with a look-up table recording the mapping relations of magnitudes of multiple difference signals and multiple digital values. In this example, the look-up table circuit may find a corresponding digital value in the look-up table according to the magnitude of the aforementioned difference signal, and output the corresponding digital value as the aforementioned digital value.

In another embodiment, the encoding circuit 163 may be realized with a look-up table circuit cooperating with an ADC. The look-up table circuit is stored with a look-up table recording the mapping relations of magnitudes of multiple difference signals and multiple analog values. In this example, the look-up table circuit converts the aforementioned difference signal into a corresponding analog signal according to the contents of the look-up table, and the ADC converts the analog signal into the aforementioned digital value.

In practice, the storage circuit 165 may be realized with an EEPROM or multiple flip-flops, and the second reference signal generating circuit 169 may be realized with one or more addition circuits.

The error detection circuit 115 compares the second reference signal Sref2 with the feedback signal FB outputted from the sensing circuit 160 to generate the error signal. Then, the control signal generating circuit 117 generates the control signal according to the error signal to control operations of the power switch 120, so as to control the flyback power converter 100 to adjust the magnitude of the output voltage signal Sout, thereby adjusting the magnitude of the test signal TS.

The control circuit 110 may adjust the output voltage signal Sout of the flyback power converter 100 or the test signal TS to an ideal condition by adopting the aforementioned feedback control approach. In this situation, the digital value stored in the storage circuit 165 is an ideal parameter calibrated by the reference signal adjusting circuit 113.

When the control circuit 110 is coupled with an actual flyback power converter, the DAC 167 in the reference signal adjusting circuit 113 would convert the calibrated digital value stored in the storage circuit 165 into the calibrated adjustment signal dS. The second reference signal generating circuit 169 would conduct operations on the calibrated adjustment signal dS and the first reference signal Sref1 to generate the calibrated second reference signal Sref2, so that the error detection circuit 115 operates accordingly.

As can be appreciated from the foregoing descriptions, the digital value stored in the storage circuit 165 is to a certain extent a calibration value obtained by the control circuit 110 by taking the parameters of the circuit components of the flyback power converter into consideration. Accordingly, the control circuit 110 is enabled to effectively reduce the negative effect on the output voltage signal caused by the parameter variations of the circuit components in the flyback power converter by utilizing the calibrated second reference signal Sref2 to be the reference signal of the error detection circuit 115, instead of the first reference signal Sref1 outputted from the first reference signal generating circuit 111. As a result, the flyback power converter is able to generate a more ideal output voltage signal for subsequent-stage circuits.

Please refer to FIG. 2, which shows a simplified functional block diagram of a flyback power converter 200 for testing according to another embodiment of the present disclosure. The flyback power converter 200 is very similar to the disclosed flyback power converter 100. One of the differences between the two embodiments is that the sensing circuit 160 in the flyback power converter 100 is replaced by a sensing circuit 260 in the flyback power converter 200. In the embodiment of FIG. 2, the sensing circuit 260 is coupled with one terminal of the power switch 120, and configured to operably generate a corresponding feedback signal FB according to the current flowing through the primary side coil 142.

In practice, the sensing circuit 260 may be coupled between the power switch 120 and a fixed-voltage terminal, or coupled between the power switch 120 and the primary side coil 142. The aforementioned sensing circuit 260 may be realized with any kind of current-sensing circuit.

The descriptions regarding the implementations, the operations, and the related advantages of other functional blocks of the flyback power converter 100 are also applicable to the flyback power converter 200. For simplicity, the descriptions will not be repeated here.

Different functional blocks in the flyback power converter 200 may be respectively realized with different circuits, or may be integrated into a single circuit chip. For example, at least one of the power switch 120, the feedback circuit 150, and the sensing circuit 260 may be integrated into the control circuit 110.

Please refer to FIG. 3, which shows a simplified functional block diagram of a flyback power converter 300 for testing according to another embodiment of the present disclosure. The flyback power converter 300 is very similar to the disclosed flyback power converter 100. One of the differences between the two embodiments is that the method for calibrating the internal parameters adopted by a control circuit 310 of the flyback power converter 300 is somewhat different from that adopted by the disclosed control circuit 110.

The control circuit 310 in this embodiment comprises the first reference signal generating circuit 111, a reference signal adjusting circuit 313, the error detection circuit 115, and the control signal generating circuit 117. The reference signal adjusting circuit 313 is coupled with the first reference signal generating circuit 111. The reference signal adjusting circuit 313 is configured to operably generate an adjustment signal dS according to the test signal TS corresponding to the output voltage signal Sout of the flyback power converter 300 and an external reference signal Tin, and to operably generate the second reference signal Sref2 according to the adjustment signal dS and the first reference signal Sref1 when the reference signal adjusting circuit 313 is coupled with the test signal TS. The descriptions regarding the implementations, the operations, and the related advantages of the first reference signal generating circuit 111, the error detection circuit 115, and the control signal generating circuit 117 in the aforementioned embodiments are also applicable to the embodiment of FIG. 3. For simplicity, the descriptions will not be repeated here.

As shown in FIG. 3, the reference signal adjusting circuit 313 in this embodiment comprises a signal difference detection circuit 361, the encoding circuit 163, the storage circuit 165, the DAC 167, and the second reference signal generating circuit 169. The signal difference detection circuit 361 is coupled with the encoding circuit 163, and utilized for coupling with the external reference signal Tin and the test signal TS which is corresponding to the output voltage signal Sout.

In order to calibrate internal parameters of the control circuit 310, the control circuit 310 may be coupled with the flyback power converter 300 for testing before shipment. The flyback power converter 300 for testing may generate the test signal TS corresponding to an ideal output voltage signal Sout by means of simulation. One of the differences between the reference signal adjusting circuit 313 and the disclosed reference signal adjusting circuit 113 is that the first reference signal Sref1 outputted from the first reference signal generating circuit 111 is replaced by the more accurate external reference signal Tin employed by the signal difference detection circuit 361 of the reference signal adjusting circuit 313. In the test stage, the signal difference detection circuit 361 compares the test signal TS with the external reference signal Tin to generate a difference signal. The descriptions regarding the implementations, the operations, and the related advantages of the encoding circuit 163, the storage circuit 165, the DAC 167, and the second reference signal generating circuit 169 of FIG. 1 are also applicable to the embodiment of FIG. 3. For simplicity, the descriptions will not be repeated here.

Similar to the aforementioned embodiments, the sensing circuit 160 generates the corresponding feedback signal FB according to the sensing voltage of the inductive coil 146. The error detection circuit 115 generates the error signal according to the feedback signal FB and the second reference signal Sref2. Then the control signal generating circuit 117 generates the control signal according to the error signal to control operations of the power switch 120, so as to control the flyback power converter 300 to adjust the magnitude of the output voltage signal Sout, thereby adjusting the output voltage signal Sout and the magnitude of the corresponding test signal TS.

The control circuit 310 may adjust the output voltage signal Sout of the flyback power converter 300 or the test signal TS to an ideal condition by adopting the aforementioned feedback control approach. In this situation, the digital value stored in the storage circuit 165 is an ideal parameter calibrated by the reference signal adjusting circuit 313.

When the control circuit 310 is coupled with an actual flyback power converter, the DAC 167 of the reference signal adjusting circuit 313 would convert the calibrated digital value stored in the storage circuit 165 into the calibrated adjustment signal dS. The second reference signal generating circuit 169 would conduct operations on the calibrated adjustment signal dS and the first reference signal Sref1 to generate the calibrated second reference signal Sref2, so that the error detection circuit 115 operates accordingly.

As can be appreciated from the foregoing descriptions, the digital value stored in the storage circuit 165 is to a certain extent a calibration value obtained by the control circuit 310 by taking the parameters of the circuit components of the flyback power converter into consideration. Accordingly, the control circuit 310 is enabled to effectively reduce the negative effect on the output voltage signal caused by the parameter variations of the circuit components in the flyback power converter by utilizing the calibrated second reference signal Sref2 to be the reference signal of the error detection circuit 115, instead of the first reference signal Sref1 outputted from the first reference signal generating circuit 111. As a result, the flyback power converter is able to generate a more ideal output voltage signal for subsequent-stage circuits.

Different functional blocks in the flyback power converter 300 may be respectively realized with different circuits, or may be integrated into a single circuit chip. For example, at least one of the power switch 120, the feedback circuit 150 and the sensing circuit 160 may be integrated into the control circuit 310.

Please refer to FIG. 4, which shows a simplified functional block diagram of a flyback power converter 400 for testing according to another embodiment of the present disclosure. The flyback power converter 400 is very similar to the disclosed flyback power converter 300. One of the differences between the two embodiments is that the sensing circuit 160 in the flyback power converter 300 is replaced by the sensing circuit 260 in the flyback power converter 400. In the embodiment of FIG. 4, the sensing circuit 260 is coupled with one terminal of the power switch 120, and configured to operably generate a corresponding feedback signal FB according to the current flowing through the primary side coil 142.

In practice, the sensing circuit 260 may be coupled between the power switch 120 and a fixed-voltage terminal, or coupled between the power switch 120 and the primary side coil 142. The aforementioned sensing circuit 260 may be realized with any kind of current-sensing circuit.

The descriptions regarding the implementations, the operations, and the related advantages of other functional blocks of the flyback power converter 300 are also applicable to the flyback power converter 400. For simplicity, the descriptions will not be repeated here.

Different functional blocks in the flyback power converter 400 may be respectively realized with different circuits, or may be integrated into a single circuit chip. For example, at least one of the power switch 120, the feedback circuit 150, and the sensing circuit 260 may be integrated into the control circuit 310.

The term “voltage signal” used throughout the description and the claims may be expressed in the format of a current in implementations, and the term “current signal” used throughout the description and the claims may be expressed in the format of a voltage in implementations.

Certain terms are used throughout the description and the claims to refer to particular components. One skilled in the art appreciates that a component may be referred to as different names. This disclosure does not intend to distinguish between components that differ in name but not in function. In the description and in the claims, the term “comprise” is used in an open-ended fashion, and thus should be interpreted to mean “include, but not limited to.” The phrases “be coupled with,” “couples with,” and “coupling with” are intended to compass any indirect or direct connection. Accordingly, if this disclosure mentioned that a first device is coupled with a second device, it means that the first device may be directly or indirectly connected to the second device through electrical connections, wireless communications, optical communications, or other signal connections with/without other intermediate devices or connection means.

The term “and/or” may comprise any and all combinations of one or more of the associated listed items. In addition, the singular forms “a,” “an,” and “the” herein are intended to comprise the plural forms as well, unless the context clearly indicates otherwise.

Other embodiments of the invention will be apparent to those skilled in the art from consideration of the specification and practice of the invention disclosed herein. It is intended that the specification and examples be considered as exemplary only, with a true scope and spirit of the invention indicated by the following claims.

What is claimed is:

1. A control circuit of a flyback power converter, the flyback power converter comprising a power switch, a primary side coil, a secondary side coil, and an inductive coil, the control circuit comprising:
a first reference signal generating circuit, configured to operably generate a first reference signal;
a reference signal adjusting circuit, coupled with the first reference signal generating circuit, configured to operably generate an adjustment signal according to a test signal corresponding to an output voltage signal of the flyback power converter and the first reference signal, and to operably generate a second reference signal according to the adjustment signal and the first reference signal when the reference signal adjusting circuit is coupled with the test signal;
an error detection circuit, coupled with the reference signal adjusting circuit, configured to operably generate an error signal according to the second reference signal and a feedback signal; and
a control signal generating circuit, coupled with the error detection circuit, configured to operably generate a control signal according to the error signal to control operations of the power switch to thereby adjust the test signal;
wherein the feedback signal corresponds to a current flowing through the primary side coil or corresponds to a sensing voltage of the inductive coil.

2. The control circuit of claim 1, wherein the reference signal adjusting circuit comprises:
a signal difference detection circuit, coupled with the reference signal adjusting circuit, configured to operably generate a difference signal according to the test signal and the first reference signal;
an encoding circuit, coupled with the signal difference detection circuit, configured to operably encode the difference signal into a digital value;
a storage circuit, coupled with the encoding circuit, configured to operably store the digital value;
a digital-to-analog converter, coupled with the storage circuit, configured to operably convert the digital value into the adjustment signal; and
a second reference signal generating circuit, coupled with the digital-to-analog converter and the first reference signal generating circuit, configured to operably generate the second reference signal according to the first reference signal and the adjustment signal.

3. The control circuit of claim 2, wherein the second reference signal generating circuit is an addition circuit.

4. A control circuit of a flyback power converter, the flyback power converter comprising a primary side coil, a secondary side coil, and an inductive coil, the control circuit comprising:
a power switch, for coupling with one terminal of the primary side coil;
a first reference signal generating circuit, configured to operably generate a first reference signal;
a reference signal adjusting circuit, coupled with the first reference signal generating circuit, configured to operably generate an adjustment signal according to a test signal corresponding to an output voltage signal of the flyback power converter and the first reference signal, and to operably generate a second reference signal according to the adjustment signal and the first reference signal when the reference signal adjusting circuit is coupled with the test signal;
an error detection circuit, coupled with the reference signal adjusting circuit, configured to operably generate an error signal according to the second reference signal and a feedback signal when coupled with the flyback power converter; and
a control signal generating circuit, coupled with the error detection circuit, configured to operably generate a control signal according to the error signal to control the power switch to thereby adjust the test signal;
wherein the feedback signal corresponds to a current flowing through the primary side coil or corresponds to a sensing voltage of the inductive coil.

5. The control circuit device of claim 4, wherein the reference signal adjusting circuit comprises:
a signal difference detection circuit, coupled with the reference signal adjusting circuit, configured to operably generate a difference signal according to the test signal and the first reference signal;
an encoding circuit, coupled with the signal difference detection circuit, configured to operably encode the difference signal into a digital value;
a storage circuit, coupled with the encoding circuit, configured to operably store the digital value;
a digital-to-analog converter, coupled with the storage circuit, configured to operably convert the digital value into the adjustment signal; and
a second reference signal generating circuit, coupled with the digital-to-analog converter and the first reference signal generating circuit, configured to operably generate the second reference signal according to the first reference signal and the adjustment signal.

6. The control circuit of claim 5, wherein the second reference signal generating circuit is an addition circuit.

7. A control circuit of a flyback power converter, the flyback power converter comprising a power switch, a primary side coil, a secondary side coil, and an inductive coil, the control circuit comprising:
a first reference signal generating circuit, configured to operably generate a first reference signal;
a reference signal adjusting circuit, coupled with the first reference signal generating circuit, configured to operably generate an adjustment signal according to a test signal corresponding to an output voltage signal of the flyback power converter and an external reference signal, and to operably generate a second reference signal according to the adjustment signal and the first reference signal when the reference signal adjusting circuit is coupled with the test signal;
an error detection circuit, coupled with the reference signal adjusting circuit, configured to operably generate an error signal according to the second reference signal and a feedback signal when coupled with the flyback power converter; and
a control signal generating circuit, coupled with the error detection circuit, configured to operably generate a control signal according to the error signal to control operations of the power switch to thereby adjust the test signal;
wherein the feedback signal corresponds to a current flowing through the primary side coil or corresponds to a sensing voltage of the inductive coil.

8. The control circuit device of claim 7, wherein the reference signal adjusting circuit comprises:
a signal difference detection circuit, configured to operably generate a difference signal according to the test signal and the external reference signal when coupled with the external reference signal;
an encoding circuit, coupled with the signal difference detection circuit, configured to operably encode the difference signal into a digital value;
a storage circuit, coupled with the encoding circuit, configured to operably store the digital value;
a digital-to-analog converter, coupled with the storage circuit, configured to operably convert the digital value into the adjustment signal; and
a second reference signal generating circuit, coupled with the digital-to-analog converter and the first reference signal generating circuit, configured to operably generate the second reference signal according to the first reference signal and the adjustment signal.

9. The control circuit of claim 8, wherein the second reference signal generating circuit is an addition circuit.

10. A control circuit of a flyback power converter, the flyback power converter comprising a primary side coil, a secondary side coil, and an inductive coil, the control circuit comprising:
a power switch, for coupling with one terminal of the primary side coil;
a first reference signal generating circuit, configured to operably generate a first reference signal;
a reference signal adjusting circuit, coupled with the first reference signal generating circuit, configured to operably generate an adjustment signal according to a test signal corresponding to an output voltage signal of the flyback power converter and an external reference signal, and to operably generate a second reference signal according to the adjustment signal and the first reference signal when the reference signal adjusting circuit is coupled with the test signal;
an error detection circuit, coupled with the reference signal adjusting circuit, configured to operably generate an error signal according to the second reference signal and a feedback signal when coupled with the flyback power converter; and
a control signal generating circuit, coupled with the error detection circuit, configured to operably generate a control signal according to the error signal to control the power switch to thereby adjust the test signal;
wherein the feedback signal corresponds to a current flowing through the primary side coil or a sensing voltage of the inductive coil.

11. The control circuit device of claim 10, wherein the reference signal adjusting circuit comprises:
a signal difference detection circuit, configured to operably generate a difference signal according to the test signal and the first reference signal when coupled with the external reference signal;
an encoding circuit, coupled with the signal difference detection circuit, configured to operably encode the difference signal into a digital value;
a storage circuit, coupled with the encoding circuit, configured to operably store the digital value;
a digital-to-analog converter, coupled with the storage circuit, configured to operably convert the digital value into the adjustment signal; and
a second reference signal generating circuit, coupled with the digital-to-analog converter and the first reference signal generating circuit, configured to operably generate the second reference signal according to the first reference signal and the adjustment signal.

12. The control circuit of claim 11, wherein the second reference signal generating circuit is an addition circuit.

13. A method for calibrating a control circuit of a flyback power converter, the flyback power converter comprising a primary side coil, a secondary side coil, and an inductive coil, the control circuit comprising a first reference signal generating circuit, an error detection circuit, and a control signal generating circuit, the method comprising:
coupling the control circuit with a test signal corresponding to an output voltage signal of the flyback power converter;
utilizing the first reference signal generating circuit to generate a first reference signal;
generating an adjustment signal according to the first reference signal and the test signal;
generating a second reference signal according to the adjustment signal and the first reference signal;
utilizing the error detection circuit to generate an error signal according to the second reference signal and a feedback signal; and
utilizing the control signal generating circuit to generate a control signal according to the error signal to control a power switch coupled with the primary side coil to thereby adjust the test signal;
wherein the feedback signal corresponds to a current flowing through the primary side coil or corresponds to a sensing voltage of the inductive coil.

14. The method of claim 13, wherein the operation of generating the adjustment signal comprises:
detecting a signal difference between the test signal and the first reference signal to generate a difference signal;
encoding the difference signal into a digital value;
utilizing a storage circuit to store the digital value; and
utilizing a digital-to-analog converter to convert the digital value into the adjustment signal.

15. The method of claim 14, wherein the operation of generating the second reference signal further comprises:
adding up the first reference signal and the adjustment signal to generate the second reference signal.

16. A method for calibrating a control circuit of a flyback power converter, the flyback power converter comprising a primary side coil, a secondary side coil, and an inductive coil, the control circuit comprising a first reference signal generating circuit, an error detection circuit, and a control signal generating circuit, the method comprising:
coupling the control circuit with a test signal corresponding to an output voltage signal of the flyback power converter;
utilizing the first reference signal generating circuit to generate a first reference signal;
generating an adjustment signal according to an external reference signal and the test signal;
generating a second reference signal according to the adjustment signal and the first reference signal;
utilizing the error detection circuit to generate an error signal according to a feedback signal corresponding to the test signal and the second reference signal; and
utilizing the control signal generating circuit to generate a control signal according to the error signal to control a power switch coupled with the primary side coil to thereby adjust the test signal.

17. The method of claim 16, wherein the operation of generating the adjustment signal comprises:
detecting a signal difference between the test signal and the external reference signal to generate a difference signal;
encoding the difference signal into a digital value;
utilizing a storage circuit to store the digital value; and
utilizing a digital-to-analog converter to convert the digital value into the adjustment signal.

18. The method of claim 17, wherein the operation of generating the second reference signal further comprises:
adding up the first reference signal and the adjustment signal to generate the second reference signal.
